(19) United States
(12) Patent Application Publication
(10) Pub. No.: US 2012/0281248 A1
(43) Pub. Date: Nov. 8, 2012

(54) SYSTEM FOR REMOTE PRINTING OF NEGOTIABLE INSTRUMENTS

(75) Inventors: Robert B. Kirsh, Germantown, TN (US); Alin S. Dragos, Atlanta, GA (US); Mark V. Putman, Memphis, TN (US)

(73) Assignee: First Data Corporation, Greenwood Village, CO (US)

(21) Appl. No.: 13/284,390

(22) Filed: Oct. 28, 2011

Related U.S. Application Data
(63) Continuation-in-part of application No. 11/843,395, filed on Aug. 22, 2007.
(60) Provisional application No. 60/839,843, filed on Aug. 23, 2006.

(51) Int. Cl. G06K 15/02

(52) U.S. Cl. 358/1.14

(57) ABSTRACT

In a method of printing a negotiable instrument remotely, a request for the negotiable instrument is received at a host computer system. The request includes at least the monetary amount of the negotiable instrument. Identification information is generated, and information about the negotiable instrument is recorded in a database, including at least the identification information and the monetary amount. A digital file is constructed, including content formatted for printing directly on negotiable instrument stock, and the digital file is sent via an electronic communication interface to a remote location for printing. In some applications, the host computer system may retrieve jurisdiction-specific information from a database for inclusion in the digital file. Such as system may facilitate remote payments such as, for example, for the timely termination of a remote employee in a state that places strict requirements on how final earnings are paid to terminated employees.

This application is a continuation-in-part of co-pending U.S. patent application Ser. No. 11/843,395, filed Aug. 22, 2007 and titled “Pre-allocated Negotiable Instrument and Presentation Instrument Purchasing and Activation Systems and Methods”, which claims priority from U.S. Provisional Patent Application 60/839,843, filed Aug. 23, 2006 and titled “Pre-allocated Negotiable Instrument and Presentation Instrument Purchasing and Activation Systems and Methods”, the entire disclosures of which are hereby incorporated by reference herein for all purposes.

### BACKGROUND OF THE INVENTION

In a large organization, occasions may arise where a paper check or other negotiable instrument is needed on short notice at a location remote from any organization employee authorized to write checks. Thus, there is a need for a system for generating negotiable instruments remotely, quickly, and securely.

### BRIEF SUMMARY OF THE INVENTION

In a first aspect, a host computer system comprises a processor, an electronic communication interface, and a computer-readable memory holding instructions. The instructions, when executed by the processor cause the host computer system to receive a request for authorization of the generation of a negotiable instrument, the request including at least a monetary amount of the negotiable instrument. Identification information is generated, and a digital file is constructed. The digital file includes content formatted for printing directly on negotiable instrument stock, the content including at least the monetary amount of the negotiable instrument and the identification information. The instructions further cause the host computer system to send, via the electronic communication interface, the digital file to a remote location for printing on negotiable instrument stock. In some embodiments, the request for authorization of the generation of the negotiable instrument includes an indication of a jurisdiction, and the instructions, when executed by the processor, further cause the system to retrieve from a database information specific to the jurisdiction, and include the information specific to the jurisdiction in the content of the digital file, formatted for printing with the negotiable instrument. The digital file may be constructed such that at least some of the content is formatted to print on a portion of the negotiable instrument stock outside the boundaries of the negotiable instrument itself. The digital file may a Portable Document Format (PDF) file. In some embodiments, the instructions, when executed by the processor, further cause the system to allocate funds from a source account to fund the negotiable instrument. In some embodiments, the instructions, when executed by the processor, further cause the system to render the allocated funds unavailable for other purposes. The digital file may be sent to the remote location via an electronic mail message. In some embodiments, the instructions, when executed by the processor, further cause the system to record the identification information and monetary amount in a database, receive a request for approval of a transaction to be conducted with the negotiable instrument, the request for approval including at least purported identification information and a purported monetary amount, compare information from the request for approval with information recorded in the database, including at least a comparison of the purported identification information and purported monetary amount with the recorded identification information and monetary amount, when the comparison indicates that the information from the request matches the information recorded in the database, transmit an approval of the transaction via the electronic communication interface, and otherwise, transmit a disapproval of the transaction. In some embodiments, the instructions, when executed by the processor, further cause the system to verify that sufficient funds are available in the source account to fund the negotiable instrument.

In another aspect, a method of authorizing the generation of a negotiable instrument comprises receiving, at a host computer system, a request for authorization of the generation of the negotiable instrument, the request including at least a monetary amount of the negotiable instrument, and generating identification information. The identification information and the monetary amount are recorded in a database. The method also includes constructing a digital file including content formatted for printing directly on negotiable instrument stock, the content including at least the monetary amount of the negotiable instrument and the identification information, and sending, from the host computer system via an electronic communication interface, the digital file to a remote location for printing on negotiable instrument stock. In some embodiments, the request for authorization of the generation of the negotiable instrument includes an indication of a jurisdiction, and the method further comprises retrieving from a database information specific to the jurisdiction, and including the information specific to the jurisdiction in the content of the digital file, formatted for printing on or with the negotiable instrument. The digital file may be constructed such that at least some of the content is formatted to print on a portion of the negotiable instrument stock outside the boundaries of the negotiable instrument itself. The digital file may be a Portable Document Format (PDF) file. In some embodiments, the method further comprises allocating funds from a source account to fund the negotiable instrument. The funds may be rendered unavailable for other purposes. In some embodiments, the method further comprises recording the identification information and monetary amount in a database; receiving a request for approval of a transaction to be conducted with the negotiable instrument, the request for approval including at least purported identification information and a purported monetary amount; comparing information from the request for approval with information recorded in the database, including at least a comparison of the purported identification information and purported monetary amount with the recorded identification information and monetary amount; when the comparison indicates that the information from the request matches the information recorded in the database, transmitting an approval of the transaction via the electronic communication interface; and otherwise, transmitting a disapproval of the transaction.

According to another aspect, a system for generating a negotiable instrument at a remote location comprises a host computer system including an electronic communication interface connected to an electronic communications network, a printer remote from the host computer system, the printer connected directly or indirectly to the host computer system via the electronic communications network, and a supply of negotiable instrument stock, each sheet of negotiable instrument stock including a pre-printed inactive negotiable instrument and a blank portion. The host computer system generates a digital file formatted for printing on a sheet of the negotiable instrument stock, the content of the digital file including a monetary amount of the negotiable instrument and indentifying information. The digital file is transmitted from the host computer system via the electronic communications network for printing on the negotiable instrument stock using the printer. In some embodiments, the content of the digital file includes information specific to a particular jurisdiction identified in a request to print the negotiable instrument. At least some of the jurisdiction-specific information may be formatted to print on the negotiable instrument itself. At least some of the jurisdiction-specific information may be formatted to print on the blank portion of the negotiable instrument stock.

### BRIEF DESCRIPTION OF THE DRAWINGS

FIG. 1 illustrates an organization with a central administrative headquarters and two remote field offices.

FIG. 2 illustrates a piece of negotiable instrument stock, in accordance with embodiments.

FIG. 3 illustrates a flow chart of a method in accordance with embodiments, for generating a negotiable instrument at a remote site.

FIG. 4 illustrates an example user interface for entering a check request into a host computer system.

FIG. 5 illustrates a digital file in accordance with embodiments, with content formatted for printing directly on the negotiable instrument stock of FIG. 2.

FIG. 6 illustrates an example electronic mail message.

FIG. 7 illustrates a printed document resulting from printing the content of FIG. 5 onto the negotiable instrument stock of FIG. 2.

FIG. 8 illustrates various entities that may be involved in the process of cashing a check according to embodiments.

FIG. 9 illustrates a flow chart of an example method of processing a check.

FIG. 10 is a block diagram illustrating an exemplary computer system in which embodiments of the present invention may be implemented.

### DETAILED DESCRIPTION OF THE INVENTION

Many employers offer various options for payment of employees. For example, an employee may enroll in a direct deposit program, wherein his or her “paycheck” is deposited directly into a checking account or other kind of account or combination of accounts. In other cases, the employee's pay may be deposited in a stored value account associated with a card or other presentation instrument. The employee can then spend his or her earnings by simply performing transactions using the card in a manner similar to using a debit or credit card.

While these payment techniques offer convenience, security, and efficiency for both the employee and employer, they may cause difficulties in some situations, for example when an employee is terminated on short notice. Some jurisdictions, for example some U.S. states, require that when an employee is terminated, he or she is presented before leaving with a paper check for payment of all wages earned. A paper check may be required even if the employee has previously enrolled in a direct deposit or similar program. In small organizations, a company owner or manager may simply write a check to the departing employee. But in larger organizations, check-writing authority may reside at a central location, so that a field office manager may be unable to write a check on the spot, and therefore may be unable to terminate an employee quickly, even immediate termination is otherwise justified. In such a situation, the employee may be placed on paid leave while a check is airmailed from a central office. Thus, the employer incurs additional unwanted expense due to the time required for arranging for the required paper check.

Some jurisdictions also mandate in detail other information that must be printed on the check presented to a departing employee. For example, in some states, the check must indicate at least one location where the check can be cashed without any fee or service charge being deducted.

Other kinds of situations may also arise where it is desirable to generate a paper check or other negotiable instrument on short notice, at a location remote from a person with check- writing authority. In another example, a construction site manager may need to quickly rent or purchase equipment to replace a piece of equipment that has broken down, or may need to purchase materials quickly, in order to avoid costly construction delays.

Embodiments of the invention provide for the remote printing of negotiable instruments, for example so that mailing delays can be avoided.

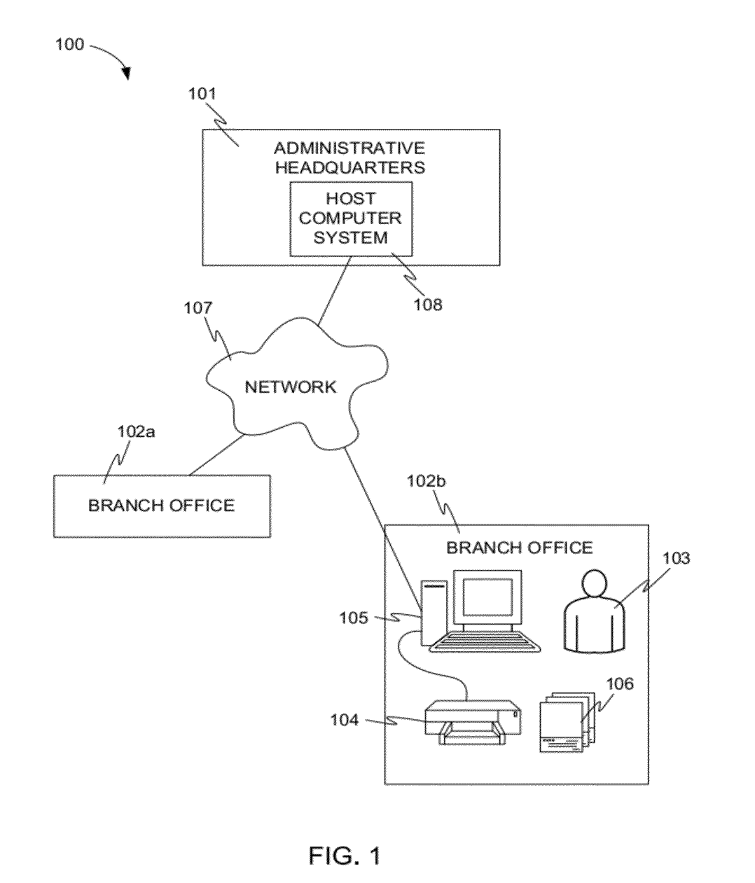

FIG. 1 illustrates an organization 100 with a central administrative headquarters 101 and two remote field offices 102a and 102b. Remote field offices 102a and 102b may be in different cities, states, or even countries than central administrative headquarters 101. However, the invention is not so limited, and embodiments may be used for generating a negotiable instrument at a “remote” location that is any distance from a person authorizing the generation of the negotiable instrument, even in the same building or office. It will also be recognized the FIG. 1 is simplified for ease of illustration, and that embodiments of the invention may be used in other kinds of organizations, including organizations having more or fewer locations than organization 100.

A manager or other employee 103 at field office 102b may have a need to issue a paper check, for example to give to a terminated employee, but may need authorization for the check from central administrative headquarters 101. (It will be recognized that the system could be used even if manager 103 does have check-writing authority.) Field office 102b is equipped with a printer 104, which may be any suitable kind of printer, for example an office laser printer, and may be connected to a computer 105. Field office 102b also keeps a supply of negotiable instrument stock 106. Preferably, administrative headquarters 101 and branch offices 102a and 102b are connected by an electronic communications network 107, which may include the Internet or another kind of network. The various offices of organization 100 may be connected in other ways as well, for example via telephone. It will be appreciated that in the configuration of FIG. 1, printer 104 is indirectly connected to host computer system 108 via network 107.

Administrative headquarters 101 may operate a host computer system 108. Host computer system 108 is shown in FIG. 1 as a single element residing at administrative headquarters, but the invention is not so limited. Host computer system 108 may include one or more computers and other devices, which may be centrally located or widely distributed. Host computer system may be operated by another entity at the behest of organization 100. Many arrangements are possible.

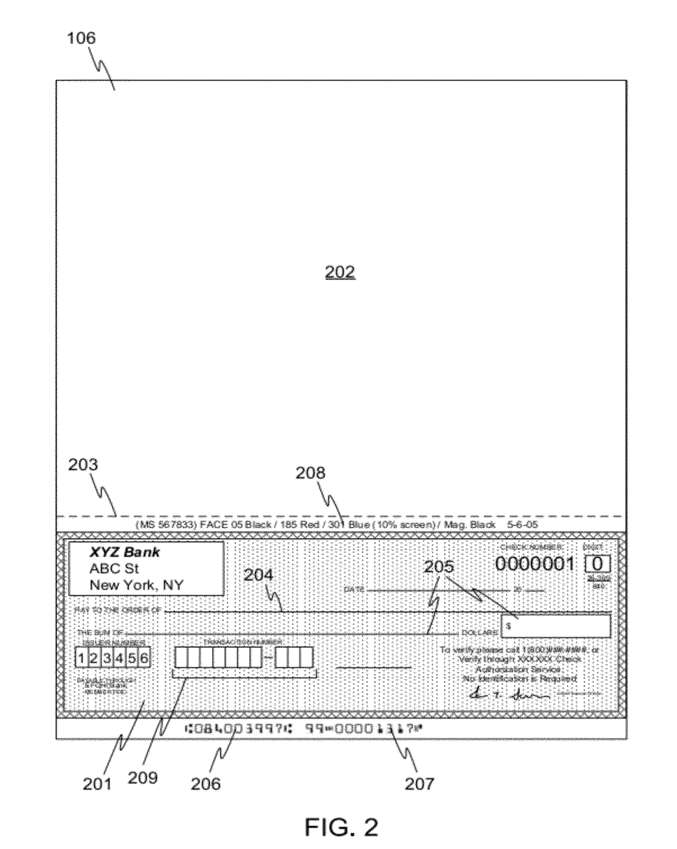

FIG. 2 illustrates a piece of negotiable instrument stock 106 in more detail. Negotiable instrument stock 106 may be, for example, paper or another thin flexible material suitable for printing with printer 104. Negotiable instrument stock 106 may be of a standard paper size, for example 8.5×11 inches (letter size), 210×297 mm (A4 size), or another standard size, although it will also be recognized that non-standard paper sizes may be used.

Example negotiable instrument stock 106 includes a pre-printed negotiable instrument form 201, and an additional information area 202, which may be blank. A perforation 203 may be provided, so that pre-printed negotiable instrument form 201 and additional information area 202 may be easily separated at an appropriate time. In the state shown in FIG. 2, pre-printed negotiable instrument form 201 is incomplete, and no part of it is negotiable. And as will be explained in more detail below, even if negotiable instrument stock is lost or stolen, it cannot practicably be used to generate an unauthorized or fraudulent check.

Example pre-printed negotiable instrument form 201 is similar to a standard check. For example, it includes an area 204 for designating a payee, and areas 205 for indicating a monetary amount, in both words and numerals. Other standardized information includes a bank routing number 206 and an account number 207, which are preferably printed in magnetic ink suitable for magnetic ink character recognition (MICR) performed in the processing of the eventual negotiable check.

Pre-printed negotiable instrument form 201 is preferably also printed using various security features, for example ink colors and half-toning patters that do not reproduce well in photocopying, and information 208 that aids in the detection of a copied or fraudulent check.

Pre-printed negotiable instrument form 201 also includes an area 209 for inclusion of a transaction number. The transaction number is an example of identification information that is generated in conjunction with the generation of a negotiable instrument.

To initiate the process of generating a negotiable instrument, manager 103 may communicate via any suitable means that a check is needed. For example, manager 103 may place a telephone call to an appropriate person at administrative headquarters 101, may communicate via an electronic mail message, or may enter information about the required check into an interactive web page served over network 107. Many other forms of communication are possible. The information communicated may include at least the name of the payee of the needed check, and the check amount. In some embodiments, the information may also include an indication of the jurisdiction in which the check will be distributed to the payee.

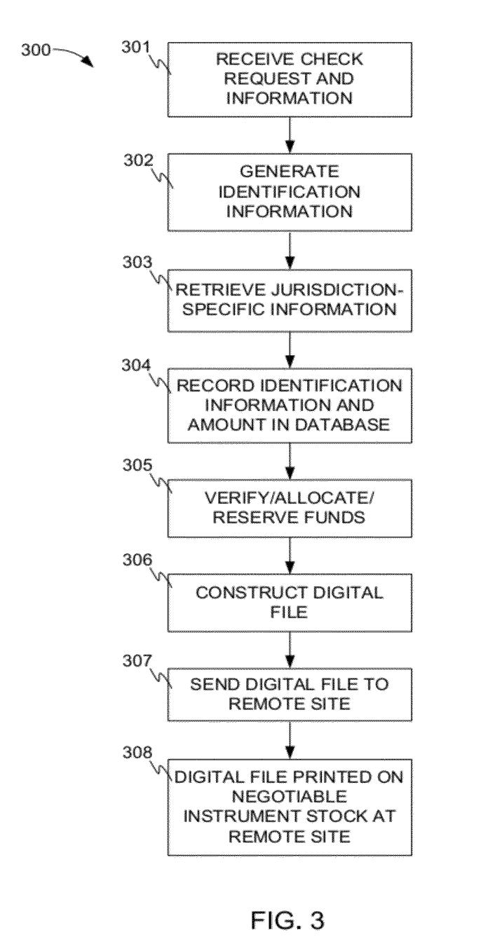

FIG. 3 illustrates a flow chart of a method 300 in accordance with embodiments, for generating the ordered negotiable instrument at a remote site. In step 301, a formal check request is received, for example by host computer system 108. Preferably, an authorized person provides the details of the check request to host computer system 108 via a macro or other user interface that guides the entry of information, to help ensure that a complete request is entered. In some embodiments, at least some of the information in the check request may be automatically transferred from information supplied electronically by the original requester.

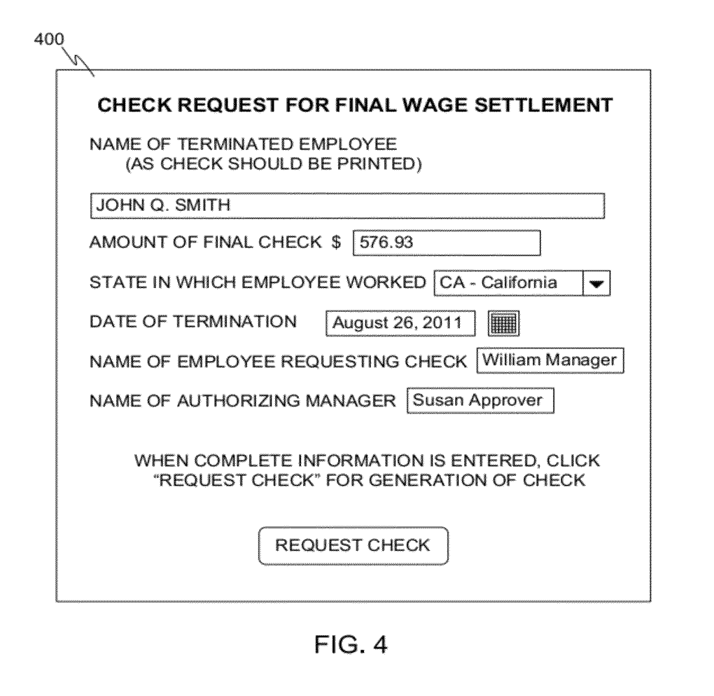

FIG. 4 illustrates an example interactive web page 400 through which an authorized person may submit a negotiable instrument request. Web page 400 includes fields for entering the name of a payee, for example a terminated employee who is to receive a final wage settlement, the amount of the check or other negotiable instrument to be generated, and a jurisdiction whose regulations govern aspects of the negotiable instrument. In this case, the jurisdiction is where the employee worked, which may have enacted regulations about what information must accompany a final settlement check.

Referring again to FIG. 3, at step 302, host computer system generates identification information for inclusion on the negotiable instrument to be generated. For example, the identification information may be a transaction number to be printed in area 209 of a check printed using negotiable instrument stock 106.

In step 303, according to some embodiments, jurisdiction-specific information is retrieved, for printing with or on the negotiable instrument. For example, host computer system may maintain a database of information indexed by jurisdiction, and may retrieve the appropriate information from the database, based on the jurisdiction indicated in the check request. The information may include, for example, information required by state law to be communicated to a terminated employee, or other information.

In step 304, information about the negotiable instrument is recorded for future use. Preferably, the recorded information includes at least the identification information (such as the transaction number) associated with the negotiable instrument, and the amount of the negotiable instrument. This recording of information is part of the process of “activating” the negotiable instrument, and the recorded information may be used in the process of approving a later transaction involving the negotiable instrument.

In step 305, host computer system may verify that funds are available in the account that will be used to fund the generated negotiable instrument. Funds sufficient for the negotiable instrument may be allocated or reserved for the specific generated negotiable instrument, and may be rendered unavailable for other uses.

In step 306, a digital file is constructed. The digital file contains content formatted for printing directly on negotiable instrument stock such as negotiable instrument stock 106. The formatted content includes at least the monetary amount of the negotiable instrument and the identification information. The digital file may be in any suitable standard or non-standard format in which the spatial location of content is fixed. For example, the digital file may conveniently be in the Portable Document Format (PDF) promulgated by Adobe Systems, Inc. of San Jose, Calif., USA. Other possible formats include, without limitation, or a Post Script file, a Tagged Image Format File (TIFF).

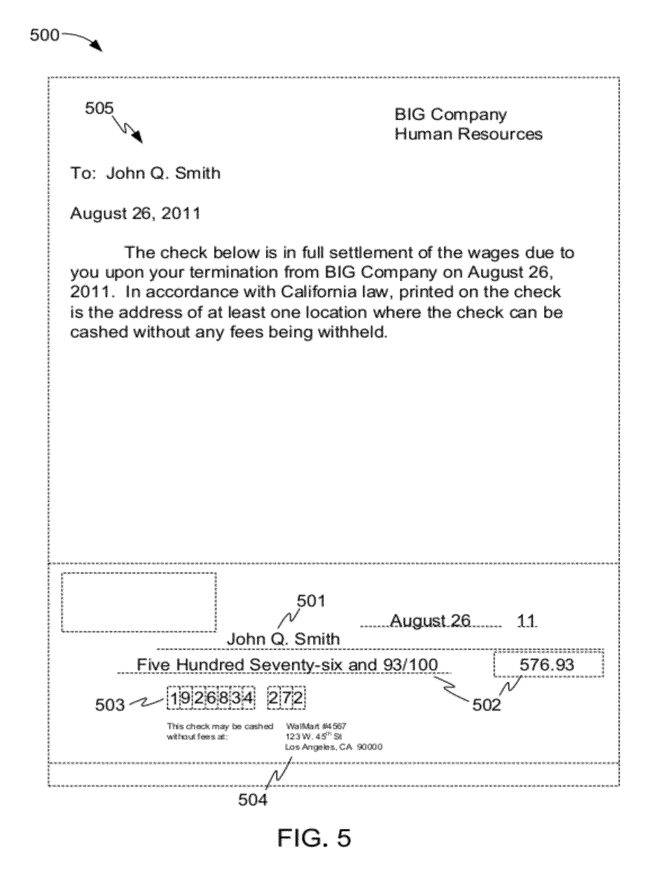

FIG. 5 illustrates a digital file 500 in accordance with embodiments, with content formatted for printing directly on negotiable instrument stock 106. Parts of negotiable instrument stock 106 are shown in phantom lines behind the textual content, to illustrate that the content is formatted to fall within certain designated areas of negotiable instrument stock 106. In this example, some information is formatted to print on the negotiable instrument form 201 portion of negotiable instrument stock 106, for example, the payee name 501, monetary amount 502 in words and numbers, the transaction number 503, and other information. In some embodiments, jurisdiction-specific information may also be formatted to print on the negotiable instrument form 201 portion of negotiable instrument stock 106. For example, some states require that a check presented to an employee upon termination include an address 504 of a location where the check can be cashed without any fees being deducted.

Other information 505 may be formatted to print in additional information area 202 of negotiable instrument stock 106. For example, an explanation of the purpose of the check may be included, and a notice that the check complies with applicable local law.

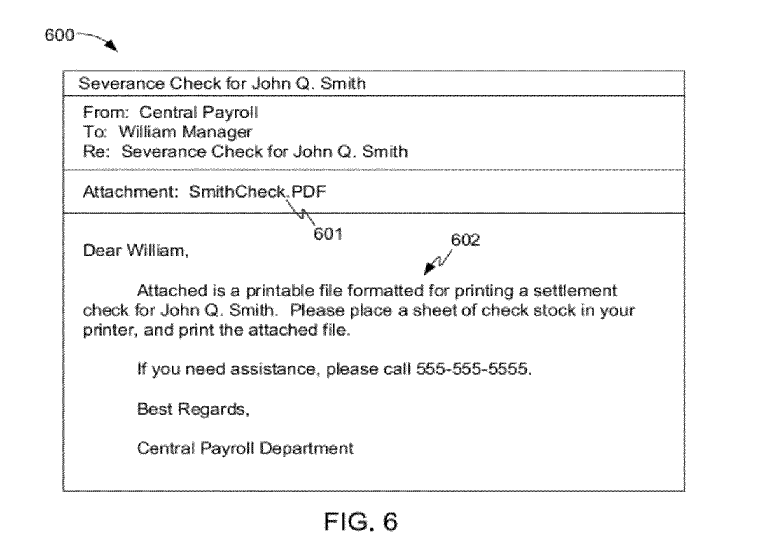

Referring again to FIG. 3, in step 307 of method 300 the digital file is sent electronically to the remote site where a negotiable instrument is needed, for example branch office 102b. The file may be sent by any suitable electronic means, but may conveniently be sent as an attachment to an electronic mail message, for example directed to manager 103. An example electronic mail message 600 is shown in FIG. 6. Electronic mail message 600 includes an attachment 601 of the digital file formatted for printing on negotiable instrument stock 106, as well as instructions 602 for printing attachment 601.

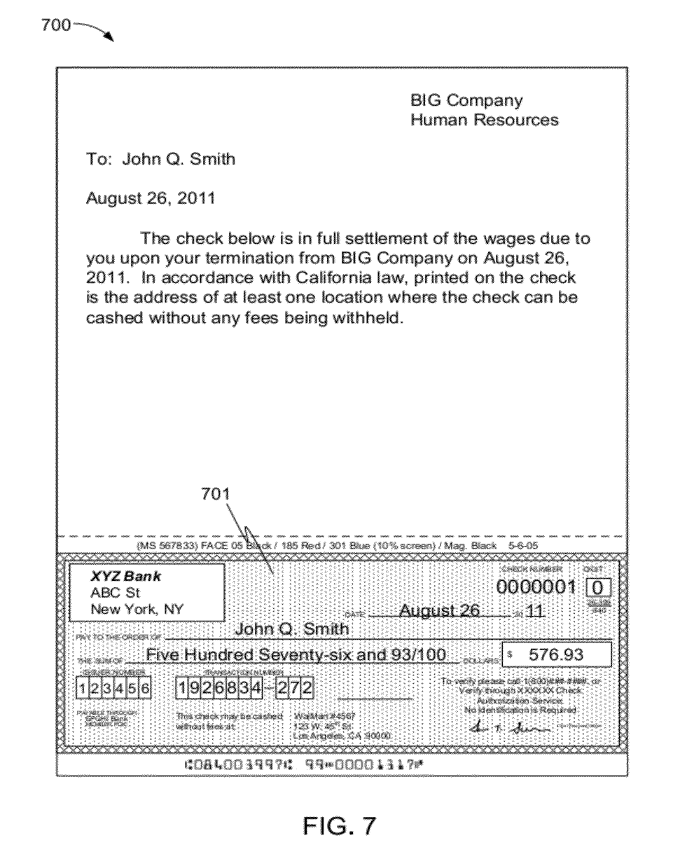

Referring again to FIG. 3, in step 308, digital file 500 is printed on negotiable instrument stock 106 at the remote site. FIG. 7 illustrates the resulting printed document 700, having the formatted content now printed in the appropriate locations on negotiable instrument stock 106.

Once document 700 is printed, the completed lower portion is a check 701 that is a negotiable instrument, and is “activated” so that it can be cashed. That is, host computer system has recorded the fact that the negotiable instrument has been generated, and has recorded enough information to uniquely identify the negotiable instrument.

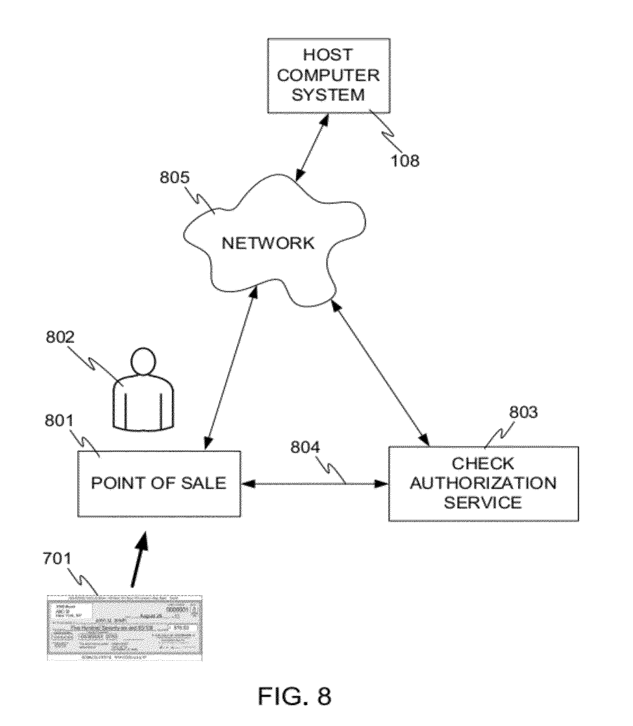

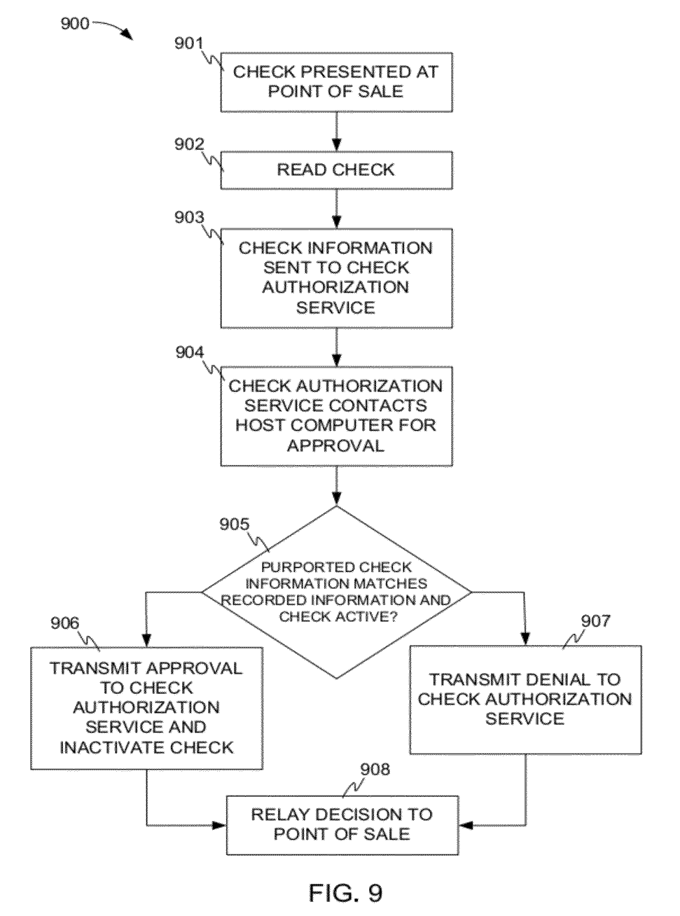

FIG. 8 illustrates various entities that may be involved in the process of cashing check 701, and FIG. 9 illustrates a flow chart of an example method 900 of processing check 701. Referring to both FIGS. 8 and 9, in step 901 of method 900, the recipient of check 701 presents check 701 at a point of sale 801. For the purposes of this disclosure, it is intended that “point of sale” be interpreted broadly to include a merchant location, a financial institution, or another location where a negotiable instrument may be presented.

At step 902, information is read from check 701. At least some of the information may be read automatically. For example, point of sale 801 may include an automated check scanner that includes a magnetic ink character recognition engine, and reads the routing and account numbers from the check. In another example, point of sale 801 may include a scanner that reads a digital image of check 701 and performs character recognition to extract information from check 701. In some embodiments, at least some of the information may be read from check 701 by a clerk 802. In any event, sufficient information is read from check 701 to uniquely identify it, preferably including the transaction number and the amount of the check. Including this information in the approval request may protect against some kinds of attempted fraud, for example an attempt to cash a check whose amount has been altered, or an attempt to cash a check that has not previously been properly issued.

In step 903, uniquely-identifying information about check 701 is sent to check authorization service 803. For example, a scanner at point of sale 801 may recognize the routing number read from check 701 as one that requires verification through check authorization service 803, or clerk 802 may recognize from the face of check 701 that verification is required.

At step 904, check authorization service 803 contacts host computer system 108 for check approval. That is, check authorization service 803 electronically transmits the information read from check 701 to host computer system 108, with a request for approval of the transaction being conducted at point of sale 801.

At step 905, host computer system 108 compares the information read from check 701 (purported to be read from a legitimate check) with the information previously stored, and checks to see if check 701 is active (has been properly issued and not previously cashed). If the information matches, and check 701 is active, host computer system 108 sends a transaction approval to check authorization service 802 at step 906. If not, host computer system 108 sends a transaction denial at step 907. At step 908, check authorization service 802 relays the approval or denial to point of sale 801, where the transaction can proceed if approved, or fails if not.

When the transaction is approved, host computer system 108 may also inactivate check 701. That is, host computer system may record in its database that check 701, uniquely identified by its transaction number and other information, has been the subject of an approved transaction wherein check 701 was cashed. Inactivating check 701 protects against a possible form of fraud, in which cashing a duplicate of check 701 may be attempted. For example, if a second attempt is made to cash check 701 or a duplicate of it, host computer system will deny the attempt because it will have recorded the fact that check 701 was already cashed.

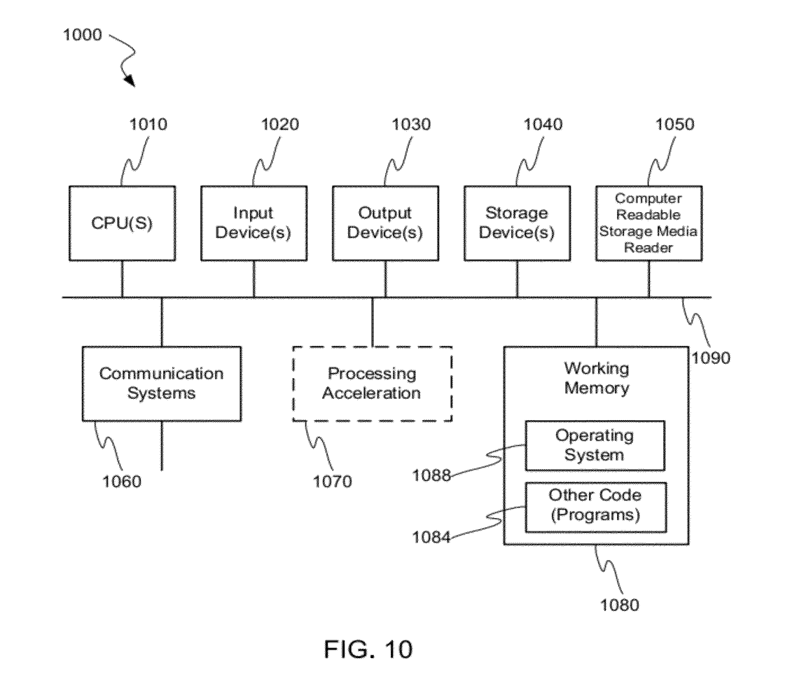

FIG. 10 is a block diagram illustrating an exemplary computer system 1000 in which embodiments of the present invention may be implemented. This example illustrates a computer system 1000 such as may be used, in whole, in part, or with various modifications, to provide the functions of host computer system 108 and/or other components of the invention.

Computer system 1000 is shown comprising hardware elements that may be electrically coupled via a bus 1090. The hardware elements may include one or more central processing units 1010, one or more input devices 1020 (e.g., a mouse, a keyboard, etc.), and one or more output devices 1030 (e.g., a display device, a printer, etc.). Computer system 1000 may also include one or more storage devices 1040. By way of example, storage device(s) 1040 may be disk drives, optical storage devices, solid-state storage device such as a random access memory (“RAM”) and/or a read-only memory (“ROM”), which can be programmable, flash-updateable and/or the like.

Computer system 1000 may additionally include a computer-readable storage media reader 1050, a communications system 1060 (e.g., a modem, a network card (wireless or wired), an infra-red communication device, Bluetooth™ device, cellular communication device, etc.), and working memory 1080, which may include RAM and ROM devices as described above. In some embodiments, computer system 1000 may also include a processing acceleration unit 1070, which can include a digital signal processor, a special-purpose processor and/or the like. Working memory 1080 may hold instructions that, when executed by CPU(S) 1010 cause computer system 1000 to perform aspects of the claimed invention.

Computer-readable storage media reader 1050 can further be connected to a computer-readable storage medium, together (and, optionally, in combination with storage device(s) 1040) comprehensively representing remote, local, fixed, and/or removable storage devices plus storage media for temporarily and/or more permanently containing computer-readable information. Communications system 1060 may permit data to be exchanged with a network, system, computer and/or other component described above.

Computer system 1000 may also comprise software elements, shown as being currently located within a working memory 1080, including an operating system 1084 and/or other code 1088. It will be appreciated that alternate embodiments of computer system 1000 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 1000 may include code 1088 for implementing any or all of the function of the various elements of the architecture as described herein.

The invention has now been described in detail for the purposes of clarity and understanding. However, those skilled in the art will appreciate that certain changes and modifications may be practiced within the scope of the appended claims.

What is claimed is:

1. A host computer system, comprising:
a processor;
an electronic communication interface; and
a computer-readable memory holding instructions that when executed by the processor cause the host computer system to:
receive a request for authorization of the generation of a negotiable instrument, the request including at least a monetary amount of the negotiable instrument;
generate identification information;
construct a digital file including content formatted for printing directly on negotiable instrument stock, the content including at least the monetary amount of the negotiable instrument and the identification information; and
send, via the electronic communication interface, the digital file to a remote location for printing on negotiable instrument stock.

2. The host computer system of claim 1, wherein the request for authorization of the generation of the negotiable instrument includes an indication of a jurisdiction, and wherein the instructions, when executed by the processor, further cause the system to:
retrieve from a database information specific to the jurisdiction; and
include the information specific to the jurisdiction in the content of the digital file, formatted for printing with the negotiable instrument.

3. The host computer system of claim 1, wherein the digital file is constructed such that at least some of the content is formatted to print on a portion of the negotiable instrument stock outside the boundaries of the negotiable instrument itself

4. The host computer system of claim 1, wherein the digital file is a Portable Document Format (PDF) file.

5. The host computer system of claim 1, wherein the instructions, when executed by the processor, further cause the system to allocate funds from a source account to fund the negotiable instrument.

6. The host computer system of claim 5, wherein the instructions, when executed by the processor, further cause the system to render the allocated funds unavailable for other purposes.

7. The host computer system of claim 1, wherein the digital file is sent to the remote location via an electronic mail message.

8. The host computer system of claim 5, wherein the instructions, when executed by the processor, further cause the system to:
record the identification information and monetary amount in a database;
receive a request for approval of a transaction to be conducted with the negotiable instrument, the request for approval including at least purported identification information and a purported monetary amount;
compare information from the request for approval with information recorded in the database, including at least a comparison of the purported identification information and purported monetary amount with the recorded identification information and monetary amount;
when the comparison indicates that the information from the request matches the information recorded in the database, transmit an approval of the transaction via the electronic communication interface; and
otherwise, transmit a disapproval of the transaction.

9. The host computer system of claim 1, wherein the instructions, when executed by the processor, further cause the system to verify that sufficient funds are available in the source account to fund the negotiable instrument.

10. A method of authorizing the generation of a negotiable instrument, the method comprising:
receiving, at a host computer system, a request for authorization of the generation of the negotiable instrument, the request including at least a monetary amount of the negotiable instrument;
generating identification information;
recording in a database the identification information and the monetary amount;
constructing a digital file including content formatted for printing directly on negotiable instrument stock, the content including at least the monetary amount of the negotiable instrument and the identification information; and
sending, from the host computer system via an electronic communication interface, the digital file to a remote location for printing on negotiable instrument stock.

11. The method of claim 10, wherein the request for authorization of the generation of the negotiable instrument includes an indication of a jurisdiction, the method further comprising:
retrieving from a database information specific to the jurisdiction; and
including the information specific to the jurisdiction in the content of the digital file, formatted for printing on or with the negotiable instrument.

12. The method of claim 10, wherein the digital file is constructed such that at least some of the content is formatted to print on a portion of the negotiable instrument stock outside the boundaries of the negotiable instrument itself.

13. The method of claim 10, wherein the digital file is a Portable Document Format (PDF) file.

14. The method of claim 10, further comprising allocating funds from a source account to fund the negotiable instrument.

15. The method of claim 14, further comprising rendering the allocated funds unavailable for other purposes.

16. The method of claim 10, further comprising:
recording the identification information and monetary amount in a database;
receiving a request for approval of a transaction to be conducted with the negotiable instrument, the request for approval including at least purported identification information and a purported monetary amount;
comparing information from the request for approval with information recorded in the database, including at least a comparison of the purported identification information and purported monetary amount with the recorded identification information and monetary amount;
when the comparison indicates that the information from the request matches the information recorded in the database, transmitting an approval of the transaction via the electronic communication interface; and
otherwise, transmitting a disapproval of the transaction.

17. A system for generating a negotiable instrument at a remote location, the system comprising:
a host computer system including an electronic communication interface connected to an electronic communications network;
a printer remote from the host computer system, the printer connected directly or indirectly to the host computer system via the electronic communications network; and
a supply of negotiable instrument stock, each sheet of negotiable instrument stock including a pre-printed inactive negotiable instrument and a blank portion;
wherein the host computer system generates a digital file formatted for printing on a sheet of the negotiable instrument stock, the content of the digital file including a monetary amount of the negotiable instrument and indentifying information;
and wherein the digital file is transmitted from the host computer system via the electronic communications network for printing on the negotiable instrument stock using the printer.

18. The system of claim 17, wherein the content of the digital file includes information specific to a particular jurisdiction identified in a request to print the negotiable instrument.

19. The system of claim 18, wherein at least some of the jurisdiction-specific information is formatted to print on the negotiable instrument itself

20. The system of claim 18, wherein at least some of the jurisdiction-specific information is formatted to print on the blank portion of the negotiable instrument stock.
